(19) United States
(12) Patent Application Publication
(10) Pub. No.: US 2008/0151794 A1
(43) Pub. Date: Jun. 26, 2008

(54) Apparatus, method, and computer program product for reducing uplink interference

(75) Inventor: Jani M. Moilanen, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/644,749

(22) Filed: Dec. 21, 2006

(51) Int. Cl. H04B 7/00

(52) U.S. Cl. 370/310

(57) ABSTRACT

The exemplary embodiments of the invention provide apparatuses, methods and computer program products for reducing uplink interference in a wireless communication system. The method includes: apportioning a plurality of resources in a resource space such that at least one resource of the plurality of resources not used for an uplink transmission from a terminal to an access node is located between a beginning of the resource space and at least one resource of the plurality of resources used for an uplink transmission with the terminal; and informing the terminal of the resources apportioned for the uplink transmission from the terminal to the access node.

### TECHNICAL FIELD

The teachings in accordance with the exemplary embodiments of this invention relate generally to wireless communication systems and, more specifically, relate to reducing interference in wireless communication systems using a grant architecture.

### BACKGROUND

Versions of IEEE 802.16 (also known as WiMAX) use Orthogonal Frequency Division Multiple Access (OFDMA) as a multiple access technique. In OFDMA, channels may be allocated in both time and frequency. The smallest allocation unit is called a slot. A slot is a contiguous block of m logical subchannels and n OFDM symbols (m and n being integers). Thus, in OFDMA, one OFDM symbol may contain transmissions to and/or from several mobile stations. A logical subchannel may have several physical sub-carriers (which are not necessarily adjacent to each other). For example, in 802.16's uplink PUSC zone, a slot is one subchannel by three OFDMA symbols.

### SUMMARY

In an exemplary aspect of the invention, a method is provided for reducing uplink interference in a wireless communication system. The method includes: apportioning a plurality of resources in a resource space such that at least one resource of the plurality of resources not used for an uplink transmission from a terminal to an access node is located between a beginning of the resource space and at least one resource of the plurality of resources used for an uplink transmission with the terminal; and informing the terminal of the resources apportioned for the uplink transmission from the terminal to the access node.

In another exemplary aspect of the invention, a computer program product is provided for reducing uplink interference in a wireless communication system. The computer program product includes program instructions embodied on a tangible computer-readable medium, execution of the program instructions resulting in operations including: apportioning a plurality of resources in a resource space such that at least one resource of the plurality of resources not used for an uplink transmission from a terminal to an access node is located between a beginning of the resource space and at least one resource of the plurality of resources used for an uplink transmission with the terminal; and informing the terminal of the resources apportioned for the uplink transmission from the terminal to the access node.

In a further exemplary aspect of the invention, an electronic device is provided. The electronic device includes: at least one data processor; at least one memory coupled to the at least one processor; and a transceiver coupled to the at least one data processor. The transceiver is configured to wirelessly connect to a second electronic device. A transmission with the second electronic device is scheduled by the allocation of a plurality of resources in a resource space having a beginning. The at least one data processor is configured to apportion the plurality of resources to reduce transmission interference by apportioning the plurality of resources in the resource space such that at least one resource not apportioned for the transmission is located between the beginning of the resource space and at least one resource apportioned for the transmission.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 illustrates an UL grant allocation with three grants for a physical frame in a WiMAX UL PUSC zone;

FIG. 2 shows an UL grant allocation with three oversize grants for a physical frame in a WiMAX UL PUSC zone incorporating aspects of the exemplary embodiments of the invention;

FIG. 3 shows an UL grant allocation with one dummy grant for a physical frame in a WiMAX UL PUSC zone incorporating aspects of the exemplary embodiments of the invention;

FIG. 4 shows a simplified block diagram of various electronic devices that are suitable for use in practicing the exemplary embodiments of this invention; and

FIG. 5 depicts a flowchart illustrating one non-limiting example of a method for practicing the exemplary embodiments of this invention.

### DETAILED DESCRIPTION

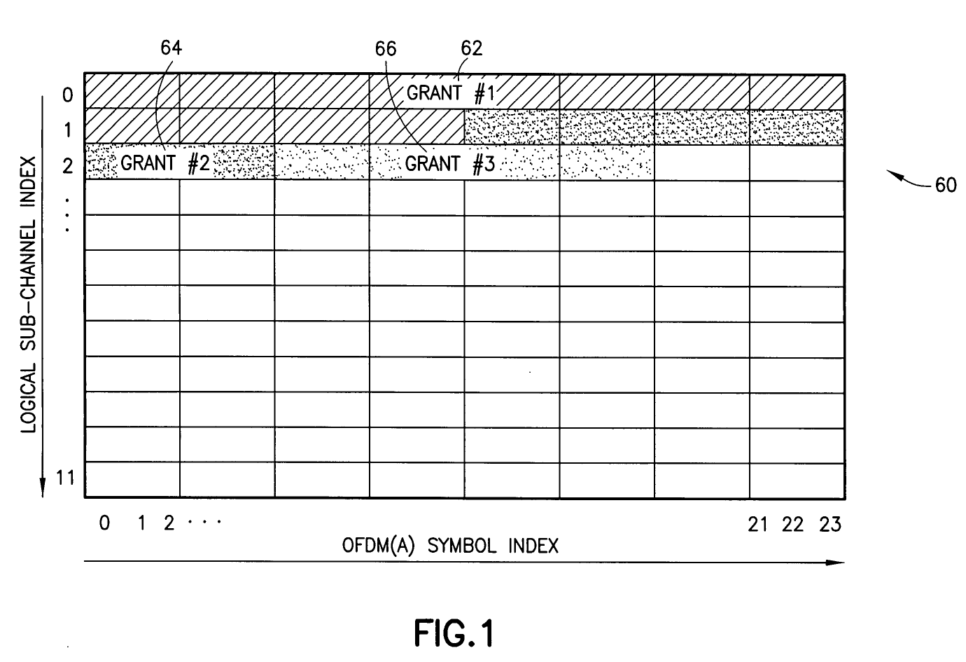

In 802.16, the base station (BS) schedules uplink (UL) transmission opportunities called grants. Grants are allocated to a physical frame starting from the first subchannel and first UL symbol (that is, the first UL symbol available for UL data transmissions) and continuing to the next slot of the same subchannel. If the edge of the UL subframe is reached, allocation continues on the next subchannel. A subsequent grant continues its allocation immediately following the previous grant. FIG. 1 illustrates an UL grant allocation with three grants for a physical frame 60 in a WiMAX UL PUSC zone. The grants include: terminal 1 with a grant of 12 slots (Grant #1 62), terminal 2 with a grant of six slots (Grant #2 64) and terminal 3 with a grant of four slots (Grant #3 66). As is apparent, the grants are sequentially placed starting from the first UL symbol in the first subchannel. Each grant immediately follows the previous one and the size of each grant corresponds to the number of slots each terminal needs.

The type of allocation shown in FIG. 1 is efficient for UL-MAP overhead since each grant immediately follows the previous one. (UL-MAP is a message that defines where grants are located in a frame.) Thus, for each grant, only a connection ID and a duration of the grant has to be included in the UL-MAP to define the location of the grant.

However, this type of allocation generally suffers from increased interference. For example, in Time Division Duplex (TDD), base stations are normally synchronized. Thus, even in low load situations, the first grant experiences almost maximal interference because neighboring BSs usually have UL transmissions on the same slots.

Exemplary embodiments of the invention describe methods, apparatus and computer program products for using grants in such a way that UL interference is reduced.

Methods are described below to reduce UL interference in low load situations (i.e. situations where the number of slots needed for UL transmissions is less than the total amount of available slots in the UL).

In one exemplary embodiment of the invention, the BS could give grants that are larger than what is needed for the uplink transmissions (“oversized grants”). That is, the grants allocated to the terminals would be for a number of slots larger than the actual number of slots the terminal needs. In such a manner, “silent slots,” that is slots that do not have transmissions, would be created in UL transmissions.

As a non-limiting example, consider a terminal that would need six slots for UL transmission. Rather than giving the terminal only the six slots it needs (i.e. making the terminal's grant a size of six slots), the terminal could be given more slots, twenty for example (a grant of twenty slots). Of the twenty slots, six contiguous slots would be filled with the UL transmissions while the remaining fourteen slots would not have transmission (i.e. the remaining fourteen slots would be silent slots). In such a manner, UL interference is reduced since there is no need to place the six slots at the very beginning of the twenty-slot grant.

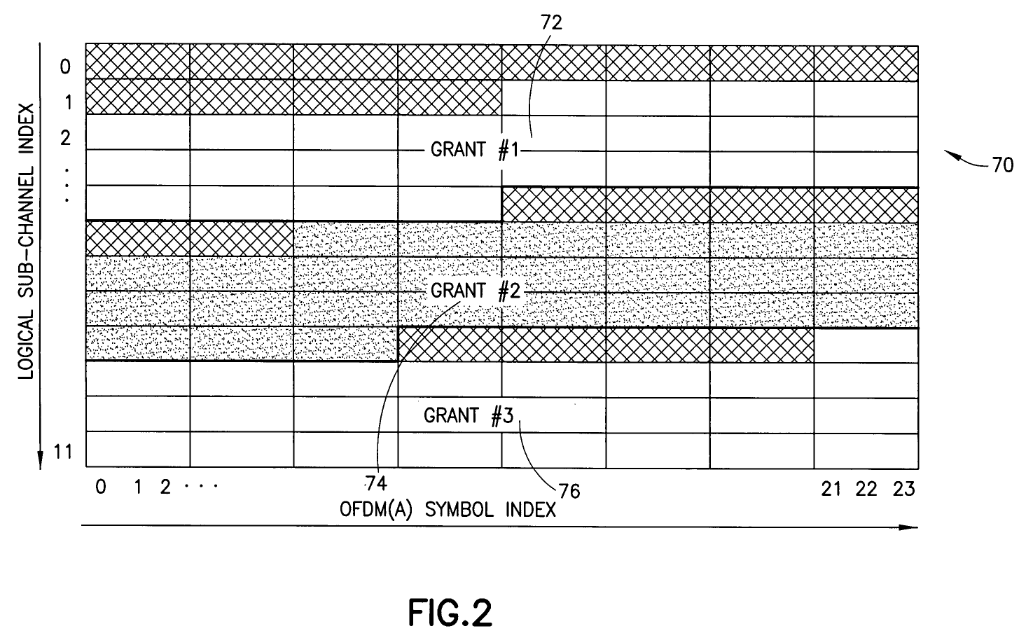

FIG. 2 shows an UL grant allocation with three oversize grants for a physical frame 70 in a WiMAX UL PUSC zone incorporating aspects of the exemplary embodiments of the invention. Similar to the example shown in FIG. 1, the physical frame in FIG. 2 has bursts for three terminals. It is assumed that terminal 1 needs a grant of twelve slots, terminal 2 needs six slots, and terminal 3 needs four slots. However, the physical frame of FIG. 2 is for a system utilizing 802.16e which typically has 96 slots available. Since only twenty-two slots are need for transmission, a number of slots remain unused (i.e. there are 74 slots not used for transmission). As such, each terminal is allocated more slots than it actually needs. Terminal 1 is given a grant of 35 slots (Grant #1 72), a grant of 31 slots is allocated for terminal 2 (Grant #2 74), and a grant of 29 slots is assigned for terminal #3 (Grant #3 76). As can be seen in FIG. 2, transmissions of terminals 2 and 3 happen at different slots than with “normal” sized grants (i.e. grants 64 and 66 in FIG. 1). If one assumes that the frame 70 in FIG. 2 is in an interfering cell for the one that uses normal sized grants (the frame 60 of FIG. 1), only terminal 1's transmission would suffer from interference.

In other embodiments, an algorithm may be used to select the size of grants and/or place the silent slots (or used slots) within a given grant. In further embodiments, the silent slots within a grant may be located at random positions. In such a manner, even though a portion of Grant #1 72 in FIG. 2 coincides with Grant #1 62 in FIG. 1, the transmission slots (i.e. the slots used for transmission) of Grant #1 72 in FIG. 2 may not coincide with the transmission slots of Grant #1 62 in FIG. 1. In such a case, clearly the inter-cell interference would be significantly reduced. In further embodiments, additional, advanced network-level algorithms or planning may be used to further minimize interference.

In another exemplary embodiment of the invention, dummy grants may be used to reduce interference. Dummy grants are grants that do not belong to any terminal (i.e. grants without an associated terminal). Dummy grants may be used to add silent slots in desired locations in the frame (similar to the previous method). One drawback of this method is that the size of the UL-MAP would increase due to the extra grants. However, the increased size of the UL-MAP will likely not be a problem in low load scenarios.

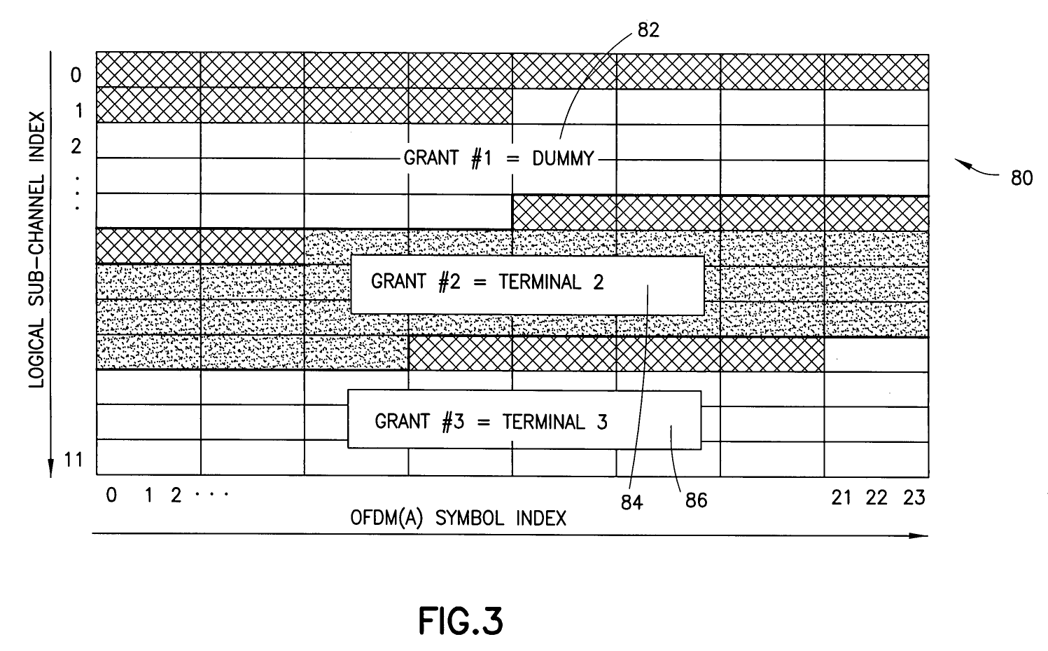

FIG. 3 shows an UL grant allocation with one dummy grant for a physical frame 80 in a WiMAX UL PUSC zone incorporating aspects of the exemplary embodiments of the invention. Unlike the frames shown in FIGS. 1 and 2, the frame in FIG. 3 has bursts for only two terminals: terminal 2 and terminal 3. It is assumed that terminal 2 needs six slots and terminal 3 needs four slots. As shown in FIG. 3, terminal 2 is given Grant #2 84 and terminal 3 is given Grant #3 86. Grant #1 82 is a dummy grant that does not have a corresponding terminal. In such a manner, the dummy grant 82 is used to reduce interference.

Although the grants shown in FIG. 3 are oversized grants (as discussed above with respect to FIG. 2), in other embodiments, dummy grants may be employed without oversized grants. As a non-limiting example, in reference to the grant allocations depicted in FIG. 1, Grant #1 62 could be a dummy grant with Grants #2 64 and #3 66 corresponding to terminals 2 and 3, respectively. In further embodiments, if dummy grants are utilized in conjunction with oversized grants, the at least one grant corresponding to a terminal may further incorporate other potential aspects of oversize grants, such as having the silent slots located at random positions, for example.

Although shown above using a frame in a WiMAX UL PUSC zone, the exemplary embodiments of the invention may be used in other access systems that have a similar continuous frame allocation scheme as the one used in WiMAX. As is thus apparent, the exemplary embodiments of the invention are not limited to a WiMAX system and may be used in conjunction with other suitable communication systems. Furthermore, although presented with respect to UL transmissions, other embodiments may be employed with respect to the scheduling of other transmissions or other types of transmissions.

In addition, the description of the exemplary embodiments of the invention may be further generalized from the descriptions presented with respect to FIGS. 1-3. As a non-limiting example, the frame 60, 70, 80 within which slots and/or grants are allocated may instead be referred to as a resource space. The resource space has a plurality of resources (e.g., slots) that may be allocated for one or more communications (e.g., UL transmissions from terminals). The resource space has a beginning (e.g., the location immediately prior to the first subchannel and first UL symbol in the frames 60, 70, 80 of FIGS. 1-3). Thus, the exemplary embodiments of the invention, as presented in FIGS. 2 and 3, provide that at least one resource not used for a communication is located between the beginning of the resource space and at least one resource used for a communication. In such a manner, as described above, interference is reduced. Further note that although FIGS. 2 and 3 are described with respect to grants, the descriptions may be generalized to the generic model of resources presented here, for example, by establishing a plurality of grants, each having a size of one symbol or, as another non-limiting example, by establishing a plurality of grants, each having a size of two symbols but with each grant only having transmission on one symbol. As is apparent, the generic resource model is flexible enough to include these and other permutations of the concepts presented herein.

With regards to additional information concerning WiMAX, reference may be made to “IEEE Standard for Local and metropolitan area networks, Part 16: Air Interface for Fixed Broadband Wireless Access Systems,” IEEE Std 802.16-2004 (Revision of IEEE Std 802.16-2001), approved Jun. 24, 2004 (referred to herein as IEEE 802.16 or 802.16). Reference may also be made to “IEEE Standard for Local and metropolitan area networks, Part 16: Air Interface for Fixed Broadband Wireless Access Systems, Amendment 2: Physical and Medium Access Control Layers for Combined Fixed and Mobile Operation in Licensed Bands,” IEEE Std 802.16e-2005 (Amendment to IEEE Std 802.16-2004), Feb. 28, 2006 (approved Dec. 7, 2005; referred to herein as IEEE 802.16e or 802.16e). As noted above, the exemplary embodiments of the invention are not limited to WiMAX and may be used in other access systems that have a similar continuous frame allocation scheme as the one used in WiMAX.

Section 6.3.5.2.1 of IEEE 802.16 states:

“The UGS is designed to support real-time service flows that generate fixed-size data packets on a periodic basis, such as T1/E1 and Voice over IP without silence suppression. The service offers fixed-size grants on a real-time periodic basis, which eliminate the overhead and latency of SS requests ad assure that grants are available to meet the flow's real-time needs. The BS shall provide Data Grant Burst IEs to the SS at periodic intervals based upon the Maximum Sustained Traffic Rate of the service flow. The size of these grants shall be sufficient to hold the fixed-length data associated with the service flow (with associated generic MAC header and Grant management subheader) but may be larger at the discretion of the BS scheduler. In order for this service to work correctly, the Request/Transmission Policy (see 11.13.12) setting shall be such that the SS is prohibited from using any contention request opportunities for this connection. The key service IEs are the Maximum Sustained Traffic, Maximum Latency, the Tolerated Jitter, and the Request/Transmission Policy. If present, the Minimum Reserved Traffic Rate parameter shall have the same value as the Maximum Sustained Traffic Rate parameter.”

“The Grant Management subheader (6.3.2.2.2) is used to pass status information from the SS to the BS regarding the state of the UGS service flow. The most significant bit of the Grant Management field is the Slip Indicator (SI) bit. The SS shall set this flag once it detects that this service flow has exceeded its transmit queue depth. Once the SS detects that the service flow's transmit queue is back within limits, it shall clear the SI flag. The flag allows the BS to provide for long term compensation for conditions, such as lost maps or clock rate mismatches, by issuing additional grants. The poll-me (PM) bit (6.3.6.3.3) may be used to request to be polled for a different, non-UGS connection.”

“The BS shall not allocate more bandwidth than the Maximum Sustained Traffic Rate parameter of the Active QoS Parameter Set, excluding the case where the SI bit of the Grant Management field is set. In this case, the BS may grant up to 1% additional bandwidth for clock rate mismatch compensation.”

Although Section 6.3.5.2.1 states that “[t]he size of these grants . . . may be larger at the discretion of the BS scheduler,” the section also states that “[t]he BS shall not allocate more bandwidth than the Maximum Sustained Traffic Rate parameter of the Active QoS Parameter Set, excluding the case where the SI bit of the Grant Management field is set.” Even if the SI bit is set, the BS may only “grant up to 1% additional bandwidth for clock rate mismatch compensation.” Thus, any such grant of additional bandwidth is exclusively for compensation purposes. Section 6.3.5.2.1 of 802.16 does not disclose or suggest that resources (e.g., additional bandwidth) be allocated in order to reduce transmission (e.g., uplink) interference in a wireless communication system.

Note that grants are requested per service flow but are given per terminal. A terminal usually has two management connections which also use a portion of bandwidth. Thus, if a terminal only has UGS (Unsolicited Grant Service, see Section 6.3.5 of 802.16) traffic, any extra bandwidth in a greater-than-needed grant allocation is likely assigned for management messages.

Generally, grants are re-assigned in/for every frame. A typical frame length is 5 ms, for example. If a terminal fails to receive a grant assigned to it (i.e. fails to receive the UL-MAP message for that particular frame), the grant will remain unused and no other terminal will be assigned that grant for that frame. In subsequent frames, that grant may be reallocated, possibly to a different terminal or, in accordance with the exemplary embodiments of the invention, as a dummy grant. As a non-limiting example, if the BS notices that a terminal is not using the allocated grant(s), the BS's scheduler may respond by allocating fewer resources (e.g., fewer grants) or no resources (e.g., no grant) for the terminal. This example is particularly relevant if the terminal only has Best Effort (BE) traffic. See Section 6.3.5 of 802.16. As an additional non-limiting example, there is also a timer (i.e. a “Lost UL-MAP Interval”) after which the BS must drop the terminal. In such a case, the terminal must then begin synchronizing (i.e. communicating) all over again, possibly with a different BS.

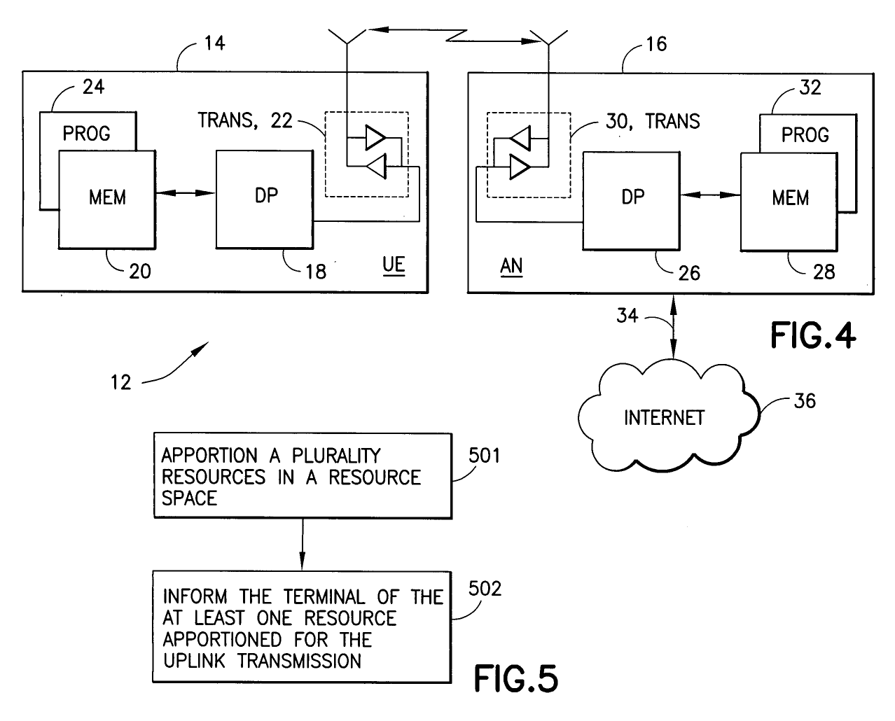

Reference is made to FIG. 4 for illustrating a simplified block diagram of various electronic devices that are suitable for use in practicing the exemplary embodiments of this invention. In FIG. 4, a wireless network 12 is adapted for communication with a user equipment (UE) 14 via an access node (AN) 16. The UE 14 includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the AN 16. Note that the TRANS 22 has at least one antenna to facilitate communication. The AN 16 includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the UE 14. Note that the TRANS 30 has at least one antenna to facilitate communication. The AN 16 is coupled via a data path 34 to one or more external networks or systems, such as the internet 36, for example.

At least one of the PROGs 24, 32 is assumed to include program instructions that, when executed by the associated DP, enable the electronic device to operate in accordance with the exemplary embodiments of this invention, as discussed herein.

In general, the various embodiments of the UE 14 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 26 of the UE 14 and the AN 16, or by hardware, or by a combination of software and hardware.

The MEMs 20, 28 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples.

Although not specified above, generally the BS or AN performs the resource allocation. In other embodiments, another electronic device in communication with the BS or AN performs the resource allocation.

FIG. 5 depicts a flowchart illustrating one non-limiting example of a method for practicing the exemplary embodiments of this invention. The method is to reduce uplink interference in a wireless communication system. Inbox 501, a plurality of resources are apportioned in a resource space. The plurality of resources are apportioned such that at least one resource of the plurality of resources not used for an uplink transmission from a terminal to an access node is located between a beginning of the resource space and at least one resource of the plurality of resources apportioned for an uplink transmission with the terminal. In box 502, the terminal is informed of the at least one resource apportioned for the uplink transmission from the terminal to the access node.

In other embodiments, apportioning the plurality of resources comprises allocating a plurality of resources for the terminal, wherein the allocated plurality of resources comprises at least one resource used by the terminal for an uplink transmission and at least one resource not used by the terminal for an uplink transmission. In further embodiments, an algorithm is used to select a size of the allocated plurality of resources. In other embodiments, an algorithm is used to place the at least one resource not used for an uplink transmission within the allocated plurality of resources. In further embodiments, the at least one resource not used for an uplink transmission is located at a random position within the allocated plurality of resources. In other embodiments, the at least one resource not used for an uplink transmission is located at a beginning of the allocated plurality of resources. In further embodiments, the resource space comprises a frame, the allocated plurality of resources comprises a grant for the terminal, and each resource of the apportioned plurality of resources comprises a slot.

In other embodiments, the terminal comprises a first terminal of a plurality of terminals and the plurality of resources are apportioned for the plurality of terminals. The apportioned plurality of resources comprises a plurality of allocations, wherein each allocation of the plurality of allocations comprises at least one resource and wherein at least one allocation of the plurality of allocations comprises an allocation that does not correspond to a terminal of the plurality of terminals and at least one allocation of the plurality of allocations corresponds to a terminal of the plurality of terminals. In further embodiments, the plurality of allocations is arranged in a sequential manner, wherein the sequential manner comprises a first allocation and wherein the least one allocation of the plurality of allocations that does not correspond to a terminal comprises the first allocation. In other embodiments, the resource space comprises a frame, each allocation of the plurality of allocations comprises a grant, and each resource of the apportioned plurality of resources comprises a slot. In further embodiments, at least one allocation that corresponds to a terminal of the plurality of terminals comprises at least one resource used by the terminal for an uplink transmission and at least one resource not used by the terminal for an uplink transmission.

In other embodiments, the wireless communication system comprises a WiMAX communication system.

In other embodiments, the method and further embodiments discussed immediately above may take the form of a computer program product to reduce uplink interference in a wireless communication system, the computer program product comprising program instructions embodied on a tangible computer-readable medium, and execution of the program instructions resulting in the operations discussed above.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method to reduce uplink interference in a wireless communication system, the method comprising:
apportioning a plurality of resources in a resource space such that at least one resource of the plurality of resources not used for an uplink transmission from a terminal to an access node is located between a beginning of the resource space and at least one resource of the plurality of resources apportioned for an uplink transmission with the terminal; and
informing the terminal of the at least one resource apportioned for the uplink transmission from the terminal to the access node.

2. The method of claim 1, wherein apportioning the plurality of resources comprises allocating a plurality of resources for the terminal, wherein the allocated plurality of resources comprises at least one resource used by the terminal for an uplink transmission and at least one resource not used by the terminal for an uplink transmission.

3. The method of claim 2, further comprising:
utilizing an algorithm to select a size of the allocated plurality of resources.

4. The method of claim 2, further comprising:
utilizing an algorithm to place the at least one resource not used for an uplink transmission within the allocated plurality of resources.

5. The method of claim 2, wherein the at least one resource not used for an uplink transmission is located at a random position within the allocated plurality of resources.

6. The method of claim 2, wherein the at least one resource not used for an uplink transmission is located at a beginning of the allocated plurality of resources.

7. The method of claim 2, wherein the resource space comprises a frame, wherein the allocated plurality of resources comprises a grant for the terminal, wherein each resource of the apportioned plurality of resources comprises a slot.

8. The method of claim 1, wherein the terminal comprises a first terminal of a plurality of terminals, wherein the plurality of resources are apportioned for the plurality of terminals, wherein the apportioned plurality of resources comprises a plurality of allocations, wherein each allocation of the plurality of allocations comprises at least one resource, wherein at least one allocation of the plurality of allocations comprises an allocation that does not correspond to a terminal of the plurality of terminals, wherein at least one allocation of the plurality of allocations corresponds to a terminal of the plurality of terminals.

9. The method of claim 8, wherein the plurality of allocations is arranged in a sequential manner, wherein the sequential manner comprises a first allocation, wherein the least one allocation of the plurality of allocations that does not correspond to a terminal comprises the first allocation.

10. The method of claim 8, wherein the resource space comprises a frame, wherein each allocation of the plurality of allocations comprises a grant, wherein each resource of the apportioned plurality of resources comprises a slot.

11. The method of claim 8, wherein at least one allocation that corresponds to a terminal of the plurality of terminals comprises at least one resource used by the terminal for an uplink transmission and at least one resource not used by the terminal for an uplink transmission.

12. The method of claim 1, wherein the wireless communication system comprises a WiMAX communication system.

13. The method of claim 1, further comprising:
utilizing at least one advanced network-level algorithm or planning to minimize interference.

14. A computer program product to reduce uplink interference in a wireless communication system, the computer program product comprising program instructions embodied on a tangible computer-readable medium, execution of the program instructions resulting in operations comprising:
apportioning a plurality of resources in a resource space such that at least one resource of the plurality of resources not used for an uplink transmission from a terminal to an access node is located between a beginning of the resource space and at least one resource of the plurality of resources used for an uplink transmission with the terminal; and
informing the terminal of the resources apportioned for the uplink transmission from the terminal to the access node.

15. The computer program product of claim 14, wherein apportioning the plurality of resources comprises allocating a plurality of resources for the terminal, wherein the allocated plurality of resources comprises at least one resource used by the terminal for an uplink transmission and at least one resource not used by the terminal for an uplink transmission.

16. The computer program product of claim 15, execution of the program instructions resulting in operations further comprising:
utilizing an algorithm to select a size of the allocated plurality of resources.

17. The computer program product of claim 15, execution of the program instructions resulting in operations further comprising:
utilizing an algorithm to place the at least one resource not used for an uplink transmission within the allocated plurality of resources.

18. The computer program product of claim 15, wherein the resource space comprises a frame, wherein the allocated plurality of resources comprises a grant for the terminal, wherein each resource of the apportioned plurality of resources comprises a slot.

19. The computer program product of claim 14, wherein the terminal comprises a first terminal of a plurality of terminals, wherein the plurality of resources are apportioned for the plurality of terminals, wherein the apportioned plurality of resources comprises a plurality of allocations, wherein each allocation of the plurality of allocations comprises at least one resource, wherein at least one allocation of the plurality of allocations comprises an allocation that does not correspond to a terminal of the plurality of terminals, wherein at least one allocation of the plurality of allocations corresponds to a terminal of the plurality of terminals.

20. The computer program product of claim 19, wherein the plurality of allocations is arranged in a sequential manner, wherein the sequential manner comprises a first allocation, wherein the least one allocation of the plurality of allocations that does not correspond to a terminal comprises the first allocation.

21. The computer program product of claim 19, wherein the resource space comprises a frame, wherein each allocation of the plurality of allocations comprises a grant, wherein each resource of the apportioned plurality of resources comprises a slot.

22. The computer program product of claim 19, wherein at least one allocation that corresponds to a terminal of the plurality of terminals comprises at least one resource used by the terminal for an uplink transmission and at least one resource not used by the terminal for an uplink transmission.

23. The computer program product of claim 14, wherein the wireless communication system comprises a WiMAX communication system.

24. The computer program product of claim 14, execution of the program instructions resulting in operations further comprising:
utilizing at least one advanced network-level algorithm or planning to minimize interference.

25. An electronic device comprising:
at least one data processor;
at least one memory coupled to the at least one processor; and
a transceiver coupled to the at least one data processor, wherein the transceiver is configured to wirelessly connect to a second electronic device, wherein a transmission with the second electronic device is scheduled by the allocation of a plurality of resources in a resource space having a beginning, wherein the at least one data processor is configured to apportion the plurality of resources to reduce interference by apportioning the plurality of resources in the resource space such that at least one resource not apportioned for transmission is located between the beginning of the resource space and at least one resource apportioned for transmission.

26. The electronic device of claim 25, wherein apportioning the plurality of resources comprises allocating a plurality of resources for transmission, wherein the allocated plurality of resources comprises at least one resource used for transmission and at least one resource not used for transmission.

27. The electronic device of claim 26, wherein the resource space comprises a frame, wherein the allocated plurality of resources comprises a grant, wherein each resource of the apportioned plurality of resources comprises a slot.

28. The electronic device of claim 25, wherein the electronic device comprises a mobile node and wherein the second electronic device comprises an access node.

29. The electronic device of claim 25, wherein the electronic device comprises an access node and wherein the second electronic device comprises a mobile node.

30. The electronic device of claim 29, wherein the mobile node comprises a first mobile node of a plurality of mobile nodes, wherein the access node is configured to form a separate wireless connection with each mobile node of the plurality of mobile nodes, wherein the plurality of resources are apportioned for the plurality of mobile nodes, wherein the apportioned plurality of resources comprises a plurality of allocations, wherein each allocation of the plurality of allocations comprises at least one resource, wherein at least one allocation of the plurality of allocations comprises an allocation that does not correspond to a mobile node of the plurality of mobile nodes, wherein at least one allocation of the plurality of allocations corresponds to a mobile node of the plurality of mobile nodes.

31. The electronic device of claim 30, wherein the resource space comprises a frame, wherein each allocation of the plurality of allocations comprises a grant, wherein each resource of the apportioned plurality of resources comprises a slot.

32. The electronic device of claim 30, wherein at least one allocation that corresponds to a mobile node of the plurality of mobile nodes comprises at least one resource used by the mobile node for an uplink transmission and at least one resource not used by the mobile node for an uplink transmission.

33. The electronic device of claim 25, wherein the electronic device performs the apportionment of the plurality of resources.

34. The electronic device of claim 25, wherein the second electronic device performs the apportionment of the plurality of resources.

35. The electronic device of claim 25, wherein the electronic device comprises a node in a WiMAX communication system.
